(19) United States
(12) Patent Application Publication
(10) Pub. No.: US 2011/0181034 A1
(43) Pub. Date: Jul. 28, 2011

(54) NURSING TRACKING STICKER

(76) Inventor: Shannon Uhle, Cocoa Beach, FL (US)

(21) Appl. No.: 12/984,127

(22) Filed: Jan. 4, 2011

Related U.S. Application Data
(60) Provisional application No. 61/298,272, filed on Jan. 26, 2010.

(51) Int. Cl. B42D 15/10; B42D 15/00

(52) U.S. Cl. 283/70; 283/81

(57) ABSTRACT

A nursing tracking sticker is placed on the outside of a nursing pad. The sticker is shaped to conform to the outside of the pad without interfering with the use of the pad or the ability of the pad to absorb any leaking breast milk. The sticker provides an easy way for mothers to track and organize their baby's feeding schedule and is easily carried with the mother at all times.

### PRIORITY

The present application claims the benefit of U.S. Provisional Application Ser. No. 61/298,272, filed Jan. 26, 2010, which is herein incorporated by reference in its entirety.

### THE FIELD OF THE INVENTION

The present invention relates to the nursing and feeding of babies. More specifically, the present invention relates to a nursing tracking sticker that a mother may use to track the times and durations of feeding a baby.

### BACKGROUND

When nursing a baby, it is important for a mother to track information about the feeding, such as the times and durations of the feedings as well as which side the baby last nursed on. This information helps the mother to ensure that the baby is receiving adequate nutrition as well as balancing the mother's milk supply and avoiding problems such as swelling or engorgement.

Previously, there has not been a suitable solution for tracking the desirable nursing information. Most mothers use a notepad to write down feeding information and thereby manage the nursing schedule. Notepads, however, are inconvenient for the mother to use. Primarily, the notepad is often not available when the mother and baby are ready to nurse. It is inconvenient for a mother to always carry the notepad around with them, and the mother can not always plan when a feeding will occur. While the goal of many mothers is to adapt their baby to a regular feeding schedule, babies still have significant variability in when they are ready to nurse. As such, the mother is not able to determine ahead of time when a feeding will occur and will often be in a location where the notepad is not available. Additionally, the need to care for other children or perform other household duties will often take the mother away from home or otherwise require her to nurse a baby in unusual locations.

It can thus be seen that a mother is often without a designated nursing notebook and thus is unable to record the feeding information as well as refer to previous feedings to decide how and when to nurse the baby. In this situation, mothers may write feeding information on a scrap of paper or another available object, but this is often lost and not included with other feeding information.

There is a need for a system to track nursing information which is convenient and easy to use, which contains the desirable information, and which is easily carried with the mother without inconvenience.

### SUMMARY OF THE INVENTION

It is an object of the present invention to provide an improved method and system for allowing a mother to track information about nursing a baby.

According to one aspect of the invention, a nursing tracking sticker is provided which is placed on the outside of a nursing pad. Placing the sticker on the outside of a nursing pad which is being worn by the mother allows the sticker to be carried on the mother without inconvenience. The tracking sticker is thus always with the mother.

This and other aspects of the present invention are realized in a nursing tracking sticker as shown and described in the following figures and related description.

### BRIEF DESCRIPTION OF THE DRAWINGS

Various embodiments of the present invention are shown and described in reference to the numbered drawings wherein:

FIG. 1 shows a front view of a nursing tracking sticker of the present invention; and

FIG. 2 shows a perspective view of the nursing tracking sticker of FIG. 1 placed on a nursing pad; and

FIGS. 3 through 5 show the nursing tracking sticker of FIG. 1 in use.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

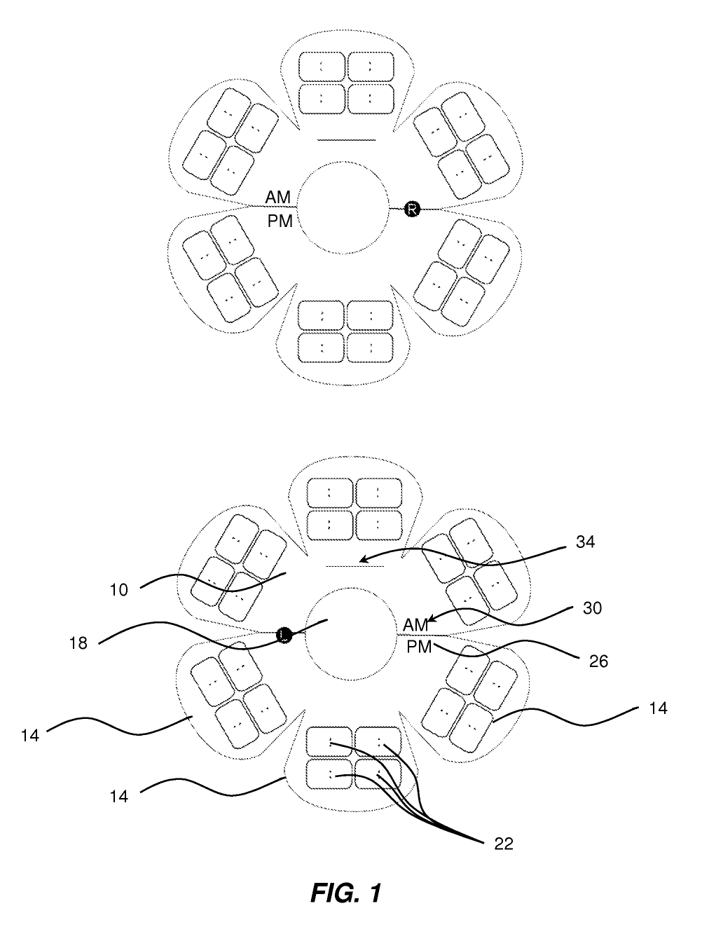

Turning now to FIG. 1, a front view of a pair of nursing tracking stickers of the present invention is shown. The sticker 10 is formed with several tabs 14 around its perimeter and has a hole 18 in the middle thereof. Each tab 14 has locations or cells 22 for writing down the start and stop times for nursing a baby, as well as the words ‘start’ and ‘stop’ printed next to the cells 22. For a preferred embodiment of the sticker 10, the sticker includes six tabs 14 which each have two start and two stop cells 22 in order to allow twelve separate feedings to be recorded on the sticker. The cells 22 are preferably arranged in start and stop columns as shown.

The sticker 10 is divided down the center as indicated at 26, separating the sticker into morning and evening halves, as indicated at 30. The sticker also includes a location 34 for recording the date on which the sticker was used. The sticker 10 is also marked L or R to designate stickers used to track feedings on the left or right breast.

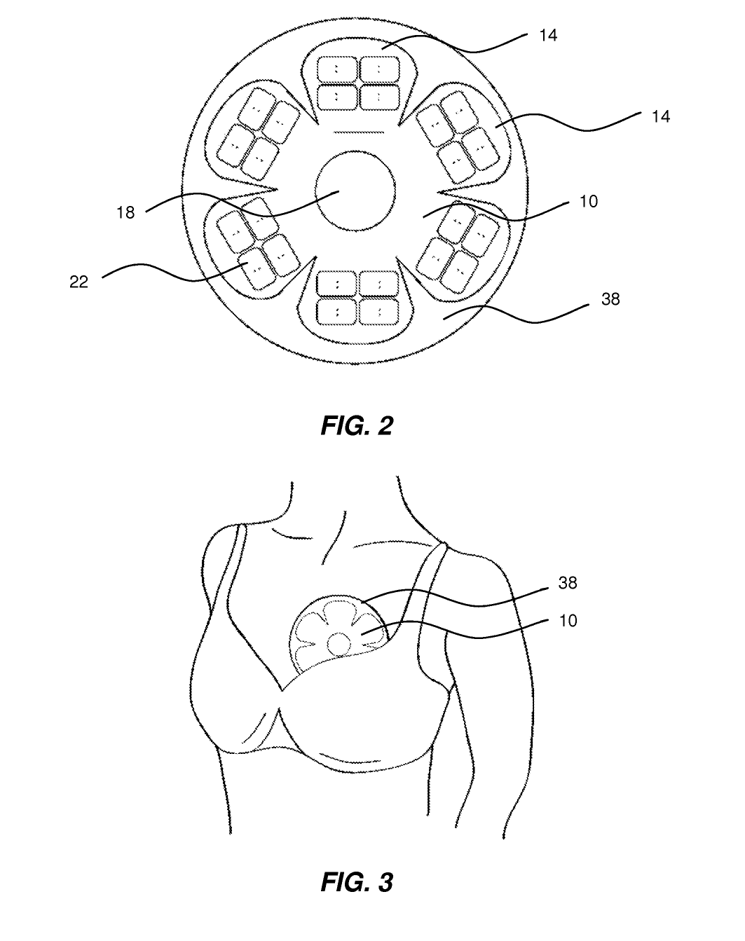

FIG. 2 shows the sticker 10 affixed to the outside of a nursing pad 38. In use, a mother places the sticker 10 on the outside of the nursing pad 38 and wears the sticker 10 along with the nursing pad 38. Most nursing mothers use nursing pads 38 to absorb any leaking breast milk. As such, it is convenient to apply the tracking sticker 10 to the nursing pad, allowing the mother to carry the sticker 10 with her without inconvenience.

The sticker tabs 14 allow the sticker 10 to conform to the convex shape of the nursing pad 38 without too many wrinkles. The cells 22 are presented to the mother while the sticker 10 is affixed to a nursing pad and allow the mother to write feeding start and stop times on the sticker 10 without removing the sticker 10 from the nursing pad 38. The hole 18 in the center of the sticker 10 is located at the center of the nursing pad 38 and allows sticker 10 to better contact and conform to the nursing pad 38.

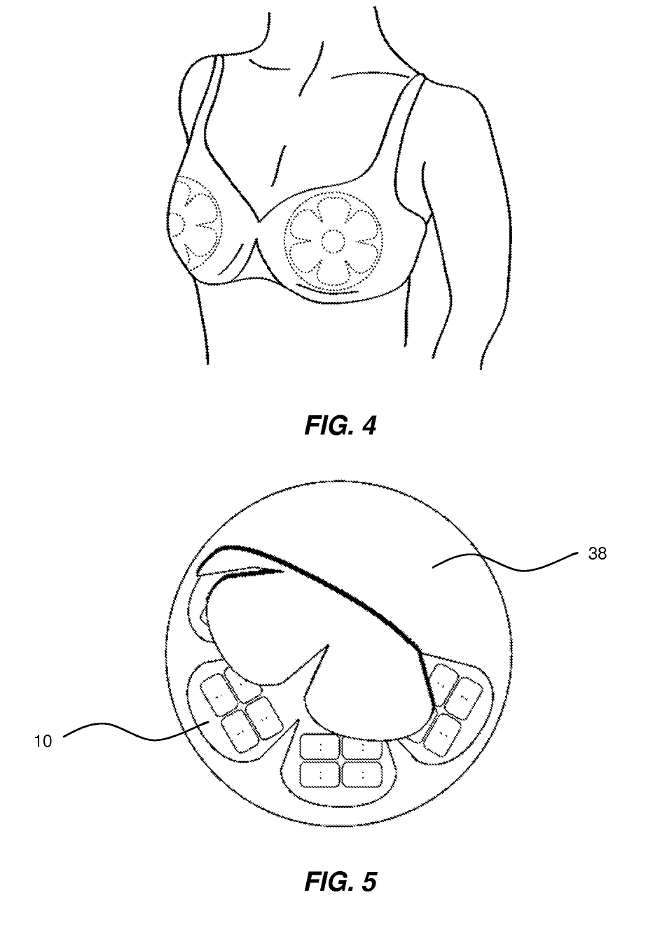

A mother would typically begin a day by placing two tracking stickers 10 outside of nursing pads 38 as shown in FIG. 2, and would wear these nursing pads during the day, as shown in FIGS. 3 and 4. When the mother feeds her baby, the mother will remove a nursing pad in order to nurse the baby. By looking at the feeding start and stop times written on the tracking sticker 10, the mother is able to determine when the baby last fed, which breast the baby last fed on and how long the baby nursed. This allows the mother to easily verify which breast the baby should now feed on and approximately how long the baby should nurse. The mother is also able to easily write the new feeding start and stop times on the sticker.

Placing the sticker 10 on the nursing pad 38 is advantageous for several reasons. Because the sticker 10 is affixed to the nursing pad 38 currently being used by the mother, it is always available to the mother when her baby is ready to nurse. Additionally, when the mother removes the nursing pad to nurse, the current day's feeding schedule is presented to the mother. The mother thus need not carry a notepad with her or write nursing times on scraps of paper which are easily lost. The mother, using the tracking stickers 10, will only need a pen or pencil to record nursing times. A pen or pencil may be carried with the mother much easier than carrying a notepad. The sticker 10 is re-adhereable to a new nursing pad if the nursing pad need be changed or to a notebook at the end of the day to keep track of the feeding times day to day.

The tracking stickers 10 are made with an adhesive which allows them to be removed from a nursing pad and re-adhered to another nursing pad or a notebook. This allows a mother to remove a sticker 10 from a used nursing pad and place the sticker on a new nursing pad during the day if this is necessary. At the end of the day, the tracking stickers 10 may be removed from the nursing pad 38 as shown in FIG. 5 and affixed to a page in a notebook or the like. The tracking stickers 10 organize the daily feeding information in a convenient manner and provide easy long term tracking of the baby's feedings when stored together in a notebook.

The nursing tracking stickers 10 of the present invention thus provide a convenient and reliable way for mothers to track the feeding schedule of their nursing babies. The sticker 10 is carried on the mother without inconvenience, eliminating situations where the mother needs to nurse but does not have a notebook or the like. The sticker 10 helps the mother organize the feeding schedules together, and is not easily lost.

There is thus disclosed an improved nursing tracking sticker. It will be appreciated that numerous changes may be made to the present invention without departing from the scope of the claims.

What is claimed is:

1. A nursing tracking sticker comprising:
a sticker having a first side for allowing a person to write thereon and a second side having an adhesive thereon for allowing the sticker to be placed on the outside of a nursing pad; and
a plurality of writing cells formed on the first side of the sticker for allowing a mother to write nursing start and stop times.

2. The tracking sticker of claim 1, wherein the sticker has a plurality of tabs formed around the outer edge thereof and a hole formed in the center thereof so as to allow the sticker to conform to a concave surface.

3. The tracking sticker of claim 1, wherein the sticker is divided into AM and PM halves to designate daytime and nighttime feedings.

4. The tracking sticker of claim 1, wherein the first side of the sticker has a location for writing the date thereon.

5. A system for tracking the nursing of a baby comprising:
a nursing pad; and
a nursing tracking sticker placed on the outside of the nursing pad, the sticker having a plurality of locations for allowing a mother to record thereon the start and stop times for nursing a baby.

6. The system of claim 5, wherein the tracking sticker has a hole formed in the center thereof for allowing the sticker to more easily conform to a round shape.

7. The system of claim 5, wherein the tracking sticker has a plurality of tabs formed around the perimeter thereof so as to allow the sticker to more easily conform to a round shape.

8. A method of tracking the nursing of a baby comprising:
selecting a nursing pad;
attaching a nursing tracking sticker to the outside of the nursing pad;
wearing the nursing pad to absorb leaked breast milk;
removing the nursing pad to nurse a baby; and
recording the nursing start and stop times on the nursing sticker.
